(19) United States
(12) Patent Application Publication
(10) Pub. No.: US 2006/0033825 A1
(43) Pub. Date: Feb. 16, 2006

(54) Method for enhancing images of non-uniform brightness

(76) Inventors: Keh-Tsong Li, Kaohsiung (TW); Keh-Yang Lee, Kaohsiung (TW); Tzu-Yang Huang, Fremont, CA (US); Han-Yi Lee, Fremont, CA (US)

Correspondence Address: Han-Yi Lee;BAYSHORE PATENT GROUP, LLC., 520 Chantecler Dr., Fremont, CA, 94539, US

(21) Appl. No.: 10/977,286

(22) Filed: Oct. 29, 2004

(30) Foreign Application Priority Data
Aug. 11, 2004 (TW) 93123985

(51) Int. Cl. G06K 9/40

(52) U.S. Cl. 348/274; 382/254

(57) ABSTRACT

The present invention relates to a method for enhancing images of non-uniform brightness. In the invention, a surround function is developed to analyze relationship of individual pixel brightness to that of surrounding pixels in an image. This brightness information is then used to set a gain function to decide the required adjustments on the values of RGB (red, green and blue) color channels of each pixel. The final value of a pixel is the sum of the adjusted values of R, G and B channels. The present method is capable of imitating human vision and adaptively adjusting brightness in every region of an image while preserving the color consistency.

### FIELD OF INVENTION

The present invention generally relates to a method for enhancing digital photo images, and, more specially, to a method for enhancing digital photo images of non-uniform brightness that are affected by excessive light sources. Images affected by excessive light sources generally exhibit high contrast and cause backlighting or reflection problems. Such problems can consequently result in overexposing and obscure images. The present invention aims to improve the aforementioned problems.

### BACKGROUND OF THE INVENTION

In the fields of digital cameras and digital camcorders, backlighting refers to a situation that the sun or a strong light source is positioned behind the objects to shoot. Under backlighting situations, images become unsatisfactory as the objects appear dark or obscure. In contrast, reflection refers to a situation that a strong light source or a strong reflected glare is contained in an image, making the image extremely bright or overexposed. Digital images or digital video clips taken under these two kinds of situations are defined as digital images of non-uniform brightness.

Digital images of non-uniform brightness are commonly seen in digital photography, which represent a difficult problem that both the industry and academic are attempting to solve. The tradition techniques typically applied in the industry are explained in the following. The first technique is called “auto exposure control”, which has become an essential element in digital cameras. A good auto exposure control adjusts the shutter and aperture for the best quality of image. However, because the settings of the shutter and aperture in auto exposure control are achieved by using the light metering method to detect the intake of light, good results can be expected in scenes under normal lighting but non-uniform lighting.

The second technique is known as Gamma correction in digital image processing. It is also very commonly used in digital cameras. Gamma correction transforms digital images via a nonlinear mathematical function. Under backlighting conditions, Gamma correction brightens darker areas in the original digital image, but may further brighten those already bright areas and lose some color information. Similarly, under reflection conditions, Gamma correction decreases the brightness of brighter areas, but may further darken those already dark objects and lose some color information.

FIG. 1A and FIG. 1B show a test image affected by backlighting and an image after being corrected by Gamma correction, respectively. Image 10 shown in FIG. 1A is a slightly dark image consisting of diamonds in high contrast and can be used as a test image to simulate backlighting. In FIG. 1B, darker areas in the image are enhanced and appear noticeably clearer; however, brighter areas become extremely bright and lose some of its information as well as its gradation.

FIG. 2A and FIG. 2B show a test image affected by reflection and an image after being corrected by Gamma correction, respectively. Image 10 shown in FIG. 2A is a slightly bright image consisting of diamonds in high contrast and can be used as a test image to simulate reflection. In FIG. 2B, bright areas in the image are enhanced and appear noticeably clearer; however, darker areas show up undesirably dark and lose some of its information.

Based on the explanation above, the two previously proposed techniques cannot effectively enhance digital images of non-uniform brightness caused by backlighting or reflection, and such problems are a major topic to be solved in digital photography.

### SUMMARY OF THE INVENTION

The main purpose of the present invention is to overcome backlighting or reflection problems in digital photography, caused by strong light sources. Strong light sources may produce high contrast in digital images, making objects to shoot too dark, too bright or overexposed and rendering the images non-uniform in color and brightness.

To achieve this goal, the present invention proposes a method for enhancing images of non-uniform brightness. In the invention, a surround function is developed to analyze relationship of individual pixel brightness to that of surrounding pixels in an image. This brightness information is then used to set a gain function to decide the required adjustments on the values of RGB (red, green and blue) color channels of each pixel. The final value of a pixel is the sum of the adjusted values of R, G and B channels. The present method can imitate human vision and adaptively adjust brightness in every region of an image while preserving color consistency.

### BRIEF DESCRIPTION OF THE DRAWINGS

The application file contains at least one drawing executed in color. Copies of this patent application publication with color drawing(s) will be provided by the Office upon request and payment of the necessary fee.

FIG. 1A and FIG. 1B show a test image affected by backlighting and an image after being corrected by conventional Gamma correction, respectively.

FIG. 2A and FIG. 2B show a test image affected by reflection and an image after being corrected by conventional Gamma correction, respectively.

FIG. 3 shows a flow chart explaining the steps of the present invention for enhancing images of non-uniform brightness.

FIG. 4 shows a gray-scale image whose brightness is enhanced by Equation (4) of the present invention.

FIG. 5 shows a gray-scale image whose brightness is enhanced by Equation (5) of the present invention.

FIG. 6A shows an image taken by a common digital camera under a backlighting condition.

FIG. 6B shows a corrected image by using the conventional Gamma correction.

FIG. 6C shows a corrected image enhanced by Equation (4) of the present invention.

FIG. 6D shows a corrected image enhanced by Equation (6) of the present invention.

FIG. 7A shows an image taken by a common digital camera under a reflection condition.

FIG. 7B shows a corrected image by using the conventional Gamma correction.

FIG. 7C shows a corrected image enhanced by Equation (5) of the present invention.

FIG. 7D shows a corrected image enhanced by Equation (7) of the present invention.

FIG. 8A shows a color image taken by a common digital camera under a backlighting condition.

FIG. 8B shows a corrected color image by using the conventional Gamma correction.

FIG. 8C shows a corrected image enhanced by Equation (12) of the present invention.

FIG. 9A shows a color image taken by a common digital camera under a reflection condition.

FIG. 9B shows a corrected color image by using the conventional Gamma correction.

FIG. 9C shows a corrected image enhanced by Equation (13) of the present invention.

### DETAILED DESCRIPTION OF THE PREFERRED EMBODIMENT

For persons of ordinary skill in the art to understand the purpose, features and effects of the present invention, the invention is described in detail as follows, along with examples and figures.

In order to circumvent the problems of non-uniform brightness caused by backlighting or reflection, the present invention proposes an enhancement technique for digital images. It imitates the adaptiveness of human eyes to improve the quality of digital images of non-uniform brightness. In human vision, the pupil adjusts to various lighting conditions by dilating or contracting to control the intake of light. With the concept of the adaptiveness, the proposed enhancement technique is able to process gray-scale and color digital images by adjusting the brightness in images.

FIG. 3 shows a flow chart explaining the steps of the present invention for enhancing images of non-uniform brightness. Method 20 proposed in the present invention comprises of step 201, step 203 and step 205, which are described as follows. Step 201 uses a surround function to analyze global image brightness and obtain an intermediate image, by calculating relationship of individual pixel brightness to that of surrounding pixels. This brightness relationship is an important piece of information obtained in step 201. Step 203 uses a given gain function to process both image 10 and the intermediate image in order to determine the RGB values that should be added to each pixel in image 10. In step 205, the determined enhancement RGB values are added to the original RGB values of their corresponding pixels in image 10 and a digital image with enhanced brightness is produced. As described above, the present invention is able to enhance image 10 via steps 201, step 203 and step 205.

The present method can be implemented on gray-scale and color digital images. Here we begin the description of the present invention with gray-scale digital images. The image processing in step 201 is defined as

$$\begin{matrix}D ( x , y ) = I ( x , y ) * F ( x , y ) \\ = {\sum }_{m = - ∞}^{∞} {\sum }_{N = - ∞}^{∞} I ( m , n ) F ( x - m , y - n )\end{matrix} \qquad Equation ( 1 )$$

where “*” represents convolution, I(x,y) represents gray-scale values in image 10, and F(x,y) is the surround function used to calculate the brightness relationship. A one-dimensional or two-dimensional low-pass filter or a vector function is chosen as F(x,y) to calculate brightness relationship of individual pixel brightness to that of surrounding pixels, followed by step 203 involving the gain function. Backlighting and reflection, two problems that the present invention aims to circumvent, are described as follows.

In a backlighting situation, the gain function in step 203 is defined as

$${C}_{Gain} \times \frac{I ( x , y )}{D ( x , y )} \qquad Equation ( 2 )$$

where D(x,y) is the intermediate image obtained in step 201 and processed by the surround function, and C_{Gain} is a gain coefficient. The main role of C_{Gain} is to control the enhancement by using Equation (2) and adaptively adjusting brightness. Since D(x,y) represents the brightness of pixel I(x,y) relative to surrounding pixels, the brightness is increased if I(x,y) is darker than the surroundings; the brightness is decreased if I(x,y) is brighter than the surroundings. Therefore, the brightness of each pixel can be adjusted adaptively.

In a reflection situation, the gain function in step 203 is defined as

$$- {C}_{Gain} \times \frac{( {I}_{max} - I ( x , y ) )}{( {I}_{max} - D ( x , y ) )} \qquad Equation ( 3 )$$

where Iₘₐₓ is the maximum value in image 10. The adaptive adjustment of brightness in a reflection situation can be achieved by using Equation (3).

In step 205, a final and enhanced image is calculated by summing the enhancement amount and the original value for each pixel in image 10. Substituting Equation (2) into Equation (1) obtains Equations (4), which represents the image processing algorithm in method 20 in a backlighting situation; and Equations (5) is obtained by substituting Equation (3) into Equation (1) and represents the image processing algorithm in method 20 in a reflection situation.
(A). In a backlighting situation:

$$\begin{matrix}\overline{I} ( x , y ) = {C}_{Gain} \times \frac{I ( x , y )}{D ( x , y )} + I ( x , y ) \\ D ( x , y ) = I ( x , y ) * F ( x , y )\end{matrix} \qquad Equation ( 4 )$$

(B). In a reflection situation:

$$\begin{matrix}\overline{I} ( x , y ) = - {C}_{Gain} \times \frac{( {I}_{max} - I ( x , y ) )}{( {I}_{max} - D ( x , y ) )} + I ( x , y ) \\ D ( x , y ) = I ( x , y ) * F ( x , y )\end{matrix} \qquad Equation ( 5 )$$

where I is the enhanced pixel value.

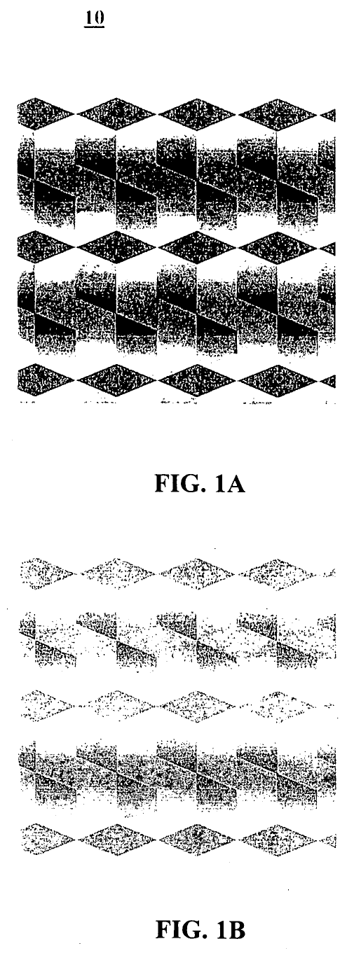

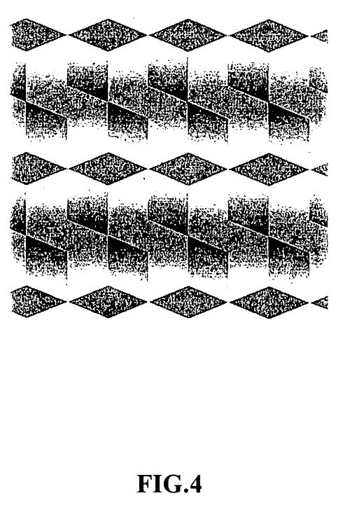

FIG. 1A, FIG. 1B and FIG. 4 demonstrate the enhancement results by using method 20 in a backlighting situation. Image 10 shown in FIG. 1A is the original gray-scale image, the image shown in FIG. 1B is the correction result by using the conventional Gamma correction, and the image shown in FIG. 4 is the enhanced image processed by Equation (4). As image 10 is an image with non-uniform brightness and high contrast, it is clearly seen that the Gamma corrected image in FIG. 1B is simply an image in which the gray-scale values of all pixels are all increased by similar amounts. It is also evident that the Gamma corrected image appears extremely bright and the diamonds in the image lose their gradation. In contrast, the gray-scale image in FIG. 4 is processed by Equation (4), and the diamonds in the figure receive different degrees of enhancement according to their surroundings. It is evident that in FIG. 4 the brightness is increased, the graphical gradation is retained, and no blurring is seen.

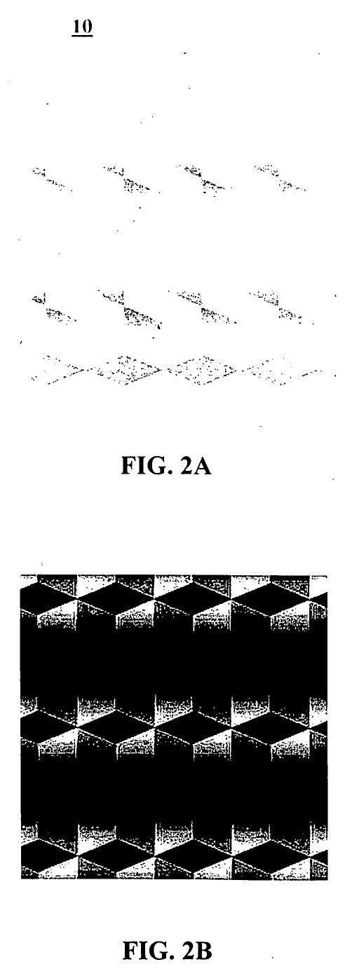

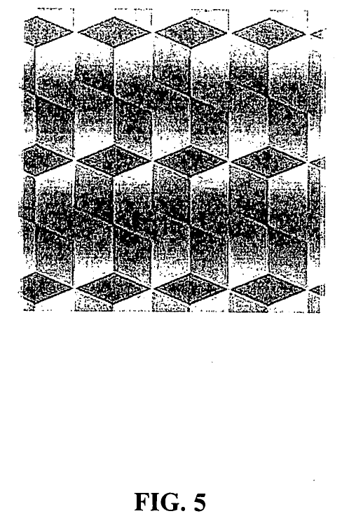

Similarly, FIG. 2A, FIG. 2B and FIG. 5 demonstrate the enhancement results by using method 20 in a reflection situation. Image 10 shown in FIG. 2A is the original gray-scale image, the image shown in FIG. 2B is the correction result by using the conventional Gamma correction, and the image shown in FIG. 5 is the enhanced image processed by Equation (5). As image 10 is a considerably bright image affected by reflection, it is clearly seen that the Gamma corrected image in FIG. 2B is simply an image in which the gray-scale values of all pixels are all decreased by similar amounts. It is also evident that the Gamma corrected image appears unnaturally dark and the diamonds in the image lose their gradation. In contrast, the gray-scale image in FIG. 5 is processed by Equation (5), and the diamonds in the figure receive different degrees of adjustment according to their surroundings. It is clearly seen that the highly bright part of the image is adjusted to a suitable degree while the relatively dark part retains its brightness and image information.

FIG. 4 demonstrates a superior result of using Equation (4) on an image, which is not degraded by noises. Noises, however, can be frequently found in digital images and are caused by surrounding environments and photographic equipments. For example, noises are easily seen in images taken by digital cameras in a dim light. To make method 20 able to deal with noises, Equation (2) is further developed to include an anti-noise coefficient. As D(x,y) is positioned in the denominator in Equation (2), noises can be undesirably amplified in a dark image if D(x,y) is equal to or less than zero. To avoid the problem, the image processing algorithm includes an anti-noise coefficient and is defined as:

$$\begin{matrix}\overline{I} ( x , y ) = {C}_{Gain} \times \frac{I ( x , y )}{D ( x , y ) + {C}_{Anti \text{-} noise}} + I ( x , y ) \\ D ( x , y ) = I ( x , y ) * F ( x , y )\end{matrix} \qquad Equation ( 6 )$$

where C_{Anti-noise} is an anti-noise coefficient.

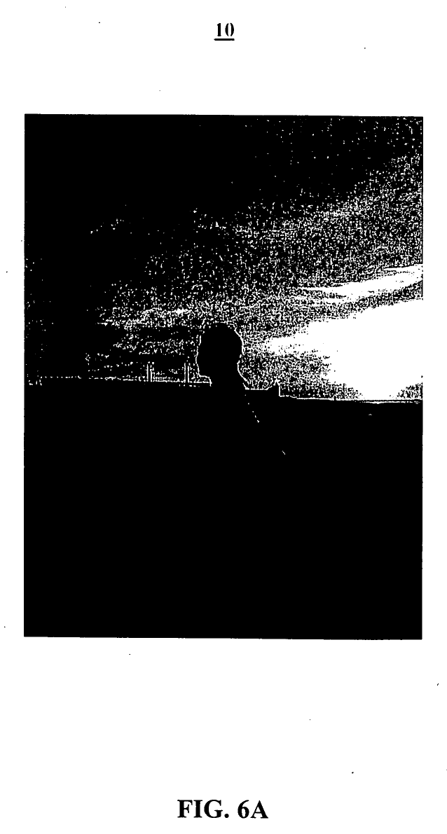

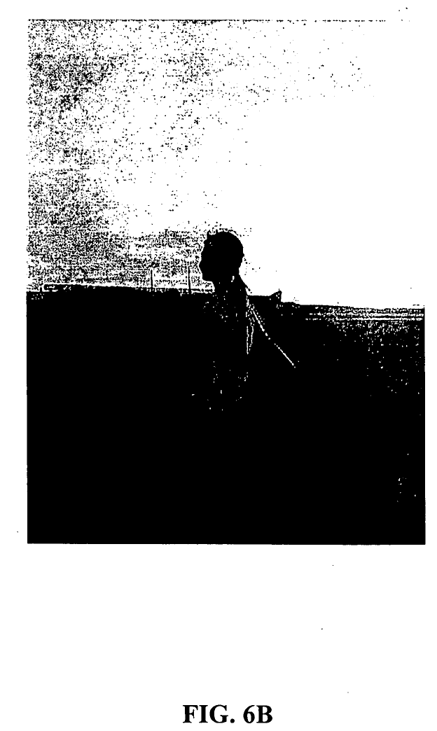

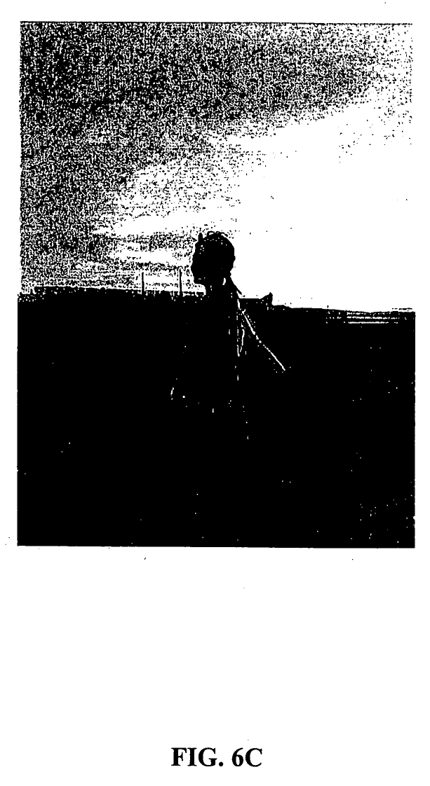

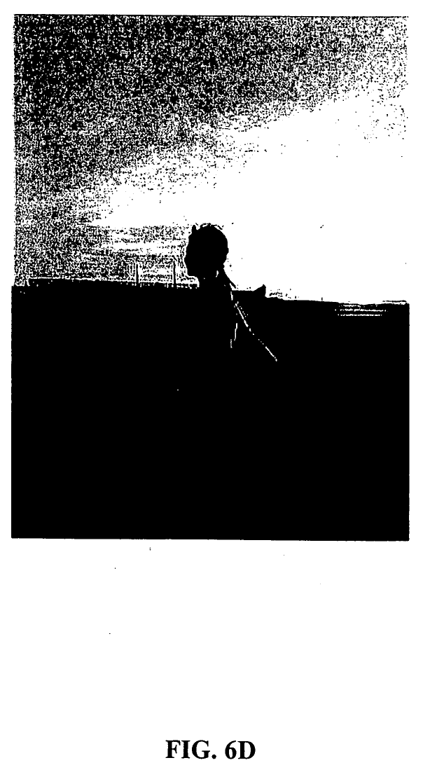

Image processing results by using Equation (6) are demonstrated in FIGS. 6A˜6D. FIG. 6A shows image 10 taken by a common digital camera in a backlighting scene. Because of the intensity and the position of the light, the girl and the beach in the image are markedly dark, and noises appear on the beach. FIG. 6B shows an image processed by the conventional Gamma correction, which appears unnaturally bright and lose image gradation as well as details on the beach. FIG. 6C shows an image processed by Equation (4), in which the brightness and contrast are enhanced, and the gradation is maintained, but noises appear on the beach. At last, image 10 is processed by Equation (6), and the result image is shown in FIG. 6D. It is apparent that the brightness of the image in FIG. 6D is adaptively enhanced on the girl and the beach, the noises are inhibited on the beach, and the backlighting problem is significantly improved.

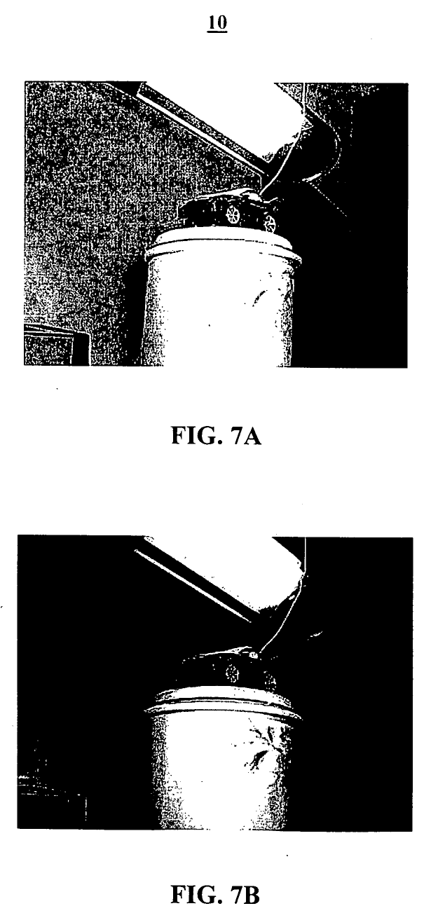

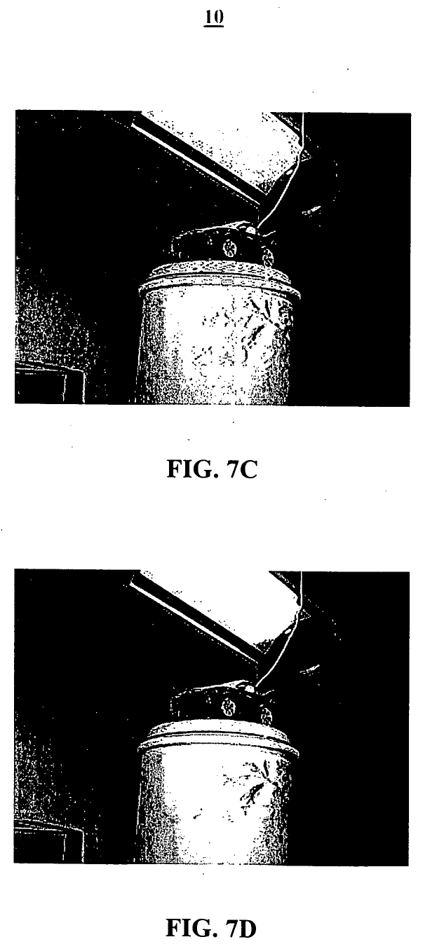

For situations under reflection, method 20 uses an image processing algorithm defined as

$$\begin{matrix}\overline{I} ( x , y ) = - {C}_{Gain} \times \frac{( {I}_{max} - I ( x , y ) )}{( {I}_{max} - D ( x , y ) ) + {C}_{Anti \text{-} noise}} + I ( x , y ) \\ D ( x , y ) = I ( x , y ) * F ( x , y )\end{matrix} \qquad Equation ( 7 )$$

where C is an anti-noise coefficient. Results by using Equation (7) are demonstrated in FIG. 7A˜7D. FIG. 7A shows image 10 taken by a common digital camera in a reflection scene. Because of the intense light source and the highly reflective glare, the tea cup in the image is overexposed, and the texture information on the cup is also lost. FIG. 7B shows an image processed by the conventional Gamma correction, in which the texture is enhanced and becomes more visible, but the dark part is rendered darker and invisible. FIG. 7C shows an image processed by Equation (5), in which the brightness is enhanced, the gradation is maintained, and the texture becomes visible, but noises appear because of the overexposure on the tea cup. At last, image 10 is processed by Equation (7), and the result image is shown in FIG. 7D. It is evident that the reflection on the tea cup is adaptively adjusted, the texture appears, and noises are avoided.

The procedure described above is designed for processing gray-scale images, and the following procedure is developed for processing color images of non- uniform brightness. For color images, brightness must be adaptively enhanced while color consistency must be retained. If a processing technique is directly applied on R (Red), G (Green) and B (Blue) color space, which are commonly used to present color images, a color shifting problem may occur. Therefore, HSI color space is used instead to process color images. HSI color space and the transformation of RGB color space to HIS color space are defined as:

$$\begin{matrix}I = \frac{1}{3} ( R + G + B ) \\ S = 1 - \frac{3}{( R + G + B )} [ min ( R , G , B ) ] \\ H = {cos}^{- 1} \{ \frac{[ ( R - G ) + ( R - B ) ] / 2}{{[ {( R - G )}^{2} + ( R - B ) ( G - B ) ]}^{1 / 2}} \}\end{matrix} \qquad Equation ( 8 )$$

where I is intensity, S is saturation and H is hue.

$$\begin{matrix}If {0}^{°} < H \leq {120}^{°} b = \frac{1}{3} ( 1 - S ) , \\ r = \frac{1}{3} [ 1 + \frac{S cos H}{cos ( {60}^{°} - H )} ] , \\ g = 1 - ( r + b ) \\ If {120}^{°} < H \leq {240}^{°} r = \frac{1}{3} ( 1 - S ) , \\ H = H - {120}^{°} , \\ g = \frac{1}{3} [ 1 + \frac{S cos H}{cos ( {60}^{°} - H )} ] , \\ b = 1 - ( r + b ) \\ If {240}^{°} < H \leq {360}^{°} g = \frac{1}{3} ( 1 - S ) , \\ H = H - {240}^{°} , \\ b = \frac{1}{3} [ 1 + \frac{S cos H}{cos ( {60}^{°} - H )} ] , \\ r = 1 - ( r + b ) \\ where , r = \frac{R}{R + G + B} , \\ g = \frac{G}{R + G + B} , \\ b = \frac{B}{R + G + B}\end{matrix} \qquad Equation ( 9 )$$

In HSI color space, the color-related information is controlled by hue H and saturation S. If color consistency is needed, according to Equation (9), hue H and saturation S must remain constant. Namely, keeping r, g and b constant can maintain color consistency and chaanging intensity I can adjust the brightness.

For color image 10 in a backlighting situation, RGB of image 10 are transformed to intensity I, followed by the processing algorithm defined as:

$$\begin{matrix}\overline{I} ( x , y ) = {C}_{Gain} \times \frac{I ( x , y )}{D ( x , y ) + {C}_{Anti \text{-} noise}} + I ( x , y ) \\ D ( x , y ) = I ( x , y ) * F ( x , y ) \\ I ( x , y ) = \frac{1}{3} ( R ( x , y ) + G ( x , y ) + B ( x , y ) )\end{matrix} \qquad Equation ( 10 )$$

where R(x,y), G(x,y), B(x,y) are the color information, I(x,y) is the intensity, and \overline{I}(x,y) is the enhanced intensity of image 10.

Next, a final and enhanced image is presented as

$$\begin{matrix}\overline{R} ( x , y ) = \overline{I} ( x , y ) \times 3 \times r ( x , y ) \\ \overline{G} ( x , y ) = \overline{I} ( x , y ) \times 3 \times g ( x , y ) \\ \overline{B} ( x , y ) = \overline{I} ( x , y ) \times 3 \times b ( x , y ) \\ r ( x , y ) = \frac{R ( x , y )}{R ( x , y ) + G ( x , y ) + B ( x , y )} \\ g ( x , y ) = \frac{G ( x , y )}{R ( x , y ) + G ( x , y ) + B ( x , y )} \\ b ( x , y ) = \frac{B ( x , y )}{R ( x , y ) + G ( x , y ) + B ( x , y )}\end{matrix} \qquad Equation ( 11 )$$

where \overline{R}(x,y), \overline{G}(x,y), \overline{B}(x,y) are the RGB values after brightness enhancement. By substituting Equation (11) into Equation (10), the image processing algorithm of method 20 can be simplified as:

$$\begin{matrix}\overline{R} ( x , y ) = {C}_{Gain} \times \frac{R ( x , y )}{D ( x , y ) + {C}_{Anti \text{-} noise}} + R ( x , y ) \\ \overline{G} ( x , y ) = {C}_{Gain} \times \frac{G ( x , y )}{D ( x , y ) + {C}_{Anti \text{-} noise}} + G ( x , y ) \\ \overline{B} ( x , y ) = {C}_{Gain} \times \frac{B ( x , y )}{D ( x , y ) + {C}_{Anti \text{-} noise}} + B ( x , y ) \\ D ( x , y ) = I ( x , y ) * F ( x , y ) \\ I ( x , y ) = \frac{1}{3} ( R ( x , y ) + G ( x , y ) + B ( x , y ) )\end{matrix} \qquad Equation ( 12 )$$

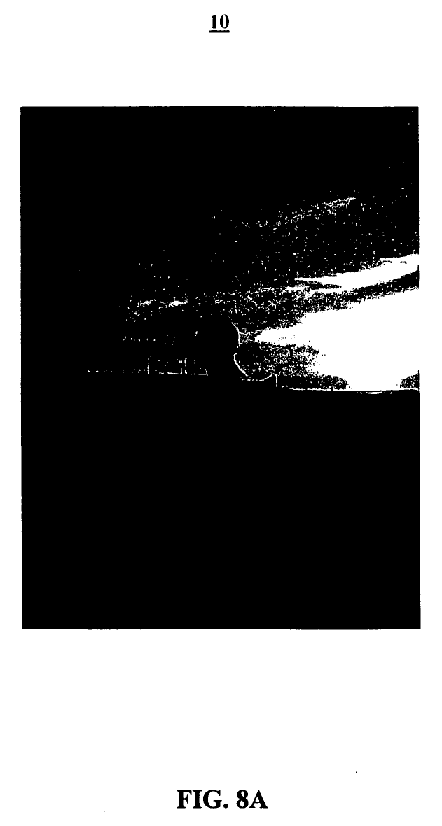

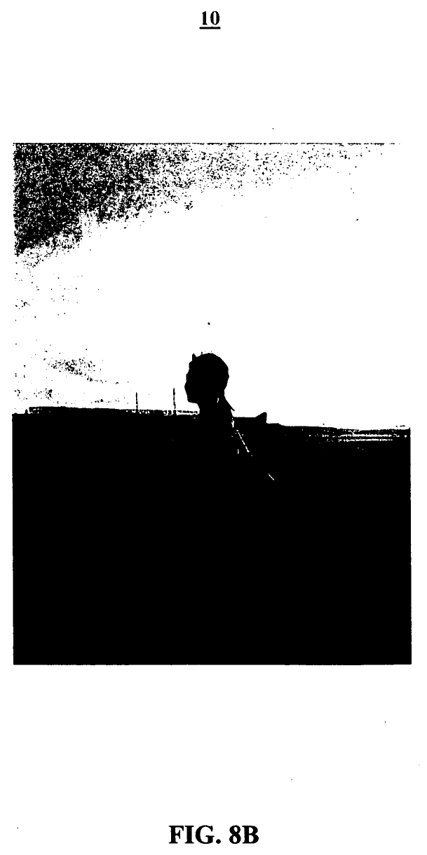

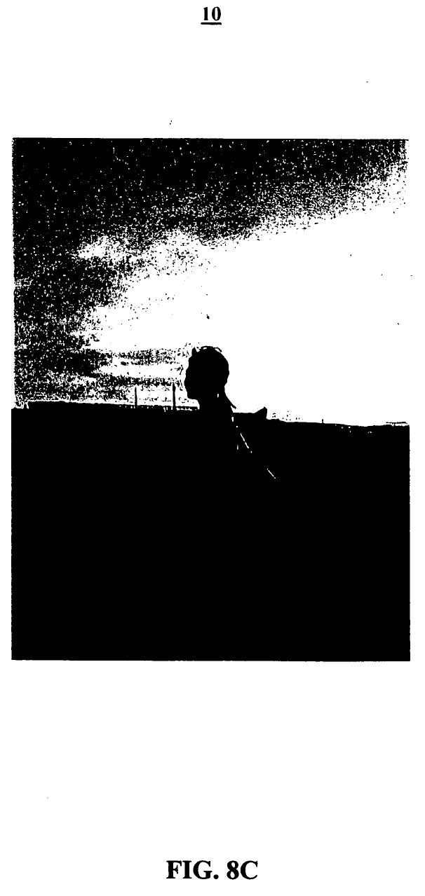

Image processing results by using Equation (12) are demonstrated in FIG. 8A˜8C. FIG. 8A shows color image 10 taken by a common digital camera in a backlighting scene. FIG. 8B shows a processed image by using the conventional Gamma correction. FIG. 8C shows a processed image by using Equation (12). By comparing the figures, it is clear that the overall image quality in FIG. 8C is better than the one in FIG. 8B, and the image processing algorithm, Equation (12), proposed in the present invention can adaptively enhance color images in a backlighting scene while maintaining color consistency.

Similarly, the proposed image processing algorithm for reflection problems can be simplified as

$$\begin{matrix}\overline{R} ( x , y ) = - {C}_{Gain} \times \frac{( {I}_{max} - R ( x , y ) )}{( {I}_{max} - D ( x , y ) ) + {C}_{Anti \text{-} noise}} + R ( x , y ) \\ \overline{G} ( x , y ) = - {C}_{Gain} \times \frac{( {I}_{max} - G ( x , y ) )}{( {I}_{max} - D ( x , y ) ) + {C}_{Anti \text{-} noise}} + G ( x , y ) \\ \overline{B} ( x , y ) = - {C}_{Gain} \times \frac{( {I}_{max} - B ( x , y ) )}{( {I}_{max} - D ( x , y ) ) + {C}_{Anti \text{-} noise}} + B ( x , y ) \\ D ( x , y ) = I ( x , y ) * F ( x , y ) \\ I ( x , y ) = \frac{1}{3} ( R ( x , y ) + G ( x , y ) + B ( x , y ) )\end{matrix} \qquad Equation ( 13 )$$

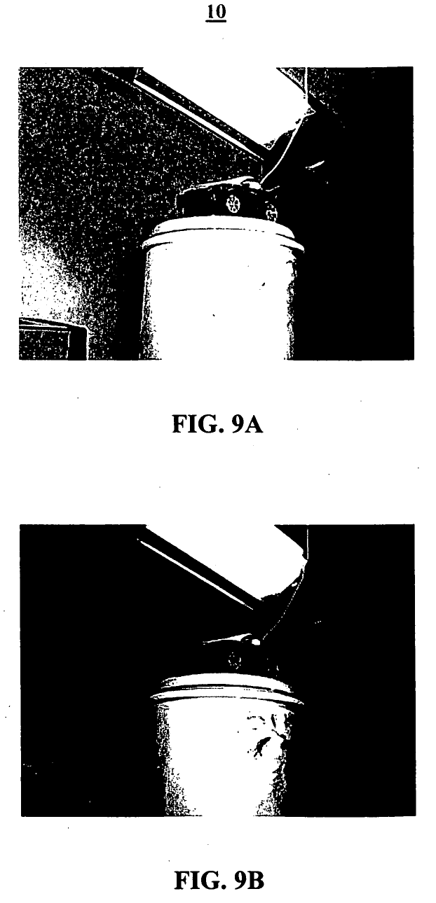

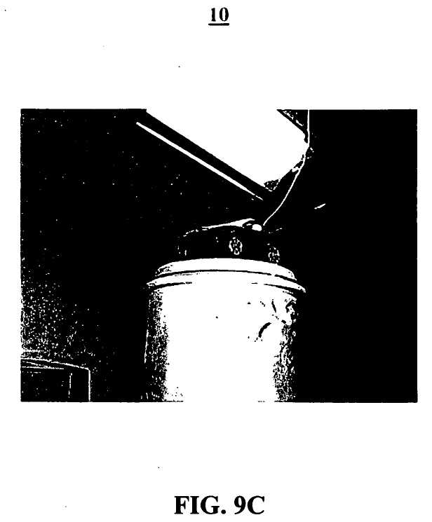

Image processing results by using Equation (13) are demonstrated in FIGS. 9A˜9C. FIG. 9A shows color image 10 in a reflection scene. FIG. 9B shows a processed image by using the conventional Gamma correction. FIG. 9C shows a processed image by using Equation (13). By comparing the figures, it is clear that the overall image quality in FIG. 9C is better than that in FIG. 9B, and the image processing algorithm, Equation (13), proposed in the present invention can adaptively enhance color images in a reflection scene while maintaining color consistency.

Moreover, method 20 in the present method can be realized in an electronic device, which can further be integrated into a digital camera, a monitor or any other image output device.

It should be noted that the functionality of the present invention is exemplified, but not limited to, the instance provided in this patent document. Definitions for certain words and phrases are provided throughout this patent document, and those of ordinary skill in the art should understand that this is by way of illustration and not of limitation, and the scope of the appended claims should be contained as broadly as the prior art will permit.

What is claimed is:

1. A method for enhancing images of non-uniform brightness, comprising:
(a) utilizing a surround function to analyze brightness uniformity of an image;
(b) applying the obtained brightness uniformity to set a gain function to decide the required adjustments on the values of RGB (red, green and blue) color channels of each pixel; and
(c) generating an enhanced image in which the final value of a pixel is the sum of the adjusted values of R, G and B channels.

2. The method of claim 1 wherein said step of utilizing a surround function includes using an equation:
$$\begin{matrix}D ( x , y ) = I ( x , y ) * F ( x , y ) \\ = {\sum }_{m = - ∞}^{∞} {\sum }_{N = - ∞}^{∞} I ( m , n ) F ( x - m , y - n )\end{matrix}$$
to process an original grey-scale image.
“*” is convolution operation, I(x,y) is the grey-scale value or brightness value of the image, F(x,y) is a surround function, and D(x,y) is an intermediate image.

3. The method of claim 2 wherein said F(x,y) can be an one-dimensional or two-dimensional low-pass filter.

4. The method of claim 2 wherein said F(x,y) can be an one-dimensional or two-dimensional vector function.

5. The method of claim 1 wherein said step of applying the obtained brightness uniformity to set a gain function includes using the equation:
$${C}_{Gain} \times \frac{I ( x , y )}{D ( x , y )}$$
to decide the required enhancements on each pixel of the original image.
I(x,y) is the original image, D(x,y) is the intermediate image, and C_{Gain} is an gain coefficient.

6. The method of claim 1 wherein said step of applying the obtained brightness uniformity to set a gain function includes using the equation:
$${C}_{Gain} \times \frac{I ( x , y )}{D ( x , y ) + {C}_{Anti \text{-} noise}}$$
to decide the required enhancements on each pixel of the original image in a backlighting condition.
I(x,y) is the original image, D(x,y) is the intermediate image, C_{Gain} is an gain coefficient, and C_{Anti-noise} is an anti-noise coefficient.

7. The method of claim 1 wherein said step of applying the obtained brightness uniformity to set a gain function includes using the equation:
$$- {C}_{Gain} \times \frac{( {I}_{max} - I ( x , y ) )}{( {I}_{max} - D ( x , y ) ) + {C}_{Anti \text{-} noise}}$$
to decide the required enhancements on each pixel of the original image in a reflection condition.
I(x,y) is the original image, D(x,y) is the intermediate image, C_{Gain} is an gain coefficient, C_{Anti-noise} is an anti-noise coefficient and Iₘₐₓ is the maximum pixel value in the original image.

8. The method as in claim 6 or claim 7 wherein said gain function is a positive scalar.

9. The method as in claim 6 or claim 7, wherein said anti-noise coefficient is a positive scalar.

10. The method of claim 1 and further comprising using the equations:
$$\begin{matrix}{C}_{Gain} \times \frac{R ( x , y )}{D ( x , y ) + {C}_{Anti \text{-} noise}} + R ( x , y ) \\ {C}_{Gain} \times \frac{G ( x , y )}{D ( x , y ) + {C}_{Anti \text{-} noise}} + G ( x , y ) \\ {C}_{Gain} \times \frac{B ( x , y )}{D ( x , y ) + {C}_{Anti \text{-} noise}} + B ( x , y )\end{matrix}$$
$$\begin{matrix}D ( x , y ) = I ( x , y ) * F ( x , y ) \\ I ( x , y ) = \frac{1}{3} ( R ( x , y ) + G ( x , y ) + B ( x , y ) )\end{matrix}$$
to process a color digital image in a backlighting condition.
I(x,y) is the original image, D(x,y) is the intermediate image, C_{Gain} is an gain coefficient, C_{Anti-noise} is an anti-noise coefficient, R(x,y) is the value of red color channel of the original image, G(x,y) is the value of green color channel of the original image, B(x,y) is the value of blue color channel of the original image.

11. The method of claim 1 and further comprising using the equations:
$$\begin{matrix}- {C}_{Gain} \times \frac{( {I}_{max} - R ( x , y ) )}{( {I}_{max} - D ( x , y ) ) + {C}_{Anti \text{-} noise}} + R ( x , y ) \\ - {C}_{Gain} \times \frac{( {I}_{max} - G ( x , y ) )}{( {I}_{max} - D ( x , y ) ) + {C}_{Anti \text{-} noise}} + G ( x , y ) \\ - {C}_{Gain} \times \frac{( {I}_{max} - B ( x , y ) )}{( {I}_{max} - D ( x , y ) ) + {C}_{Anti \text{-} noise}} + B ( x , y )\end{matrix}$$
$$\begin{matrix}D ( x , y ) = I ( x , y ) * F ( x , y ) \\ I ( x , y ) = \frac{1}{3} ( R ( x , y ) + G ( x , y ) + B ( x , y ) )\end{matrix}$$
to process a color digital image in a reflection condition.
I(x,y) is the original image, D(x,y) is the intermediate image, C_{Gain} is an gain coefficient, C_{Anti-noise} is an anti-noise coefficient, Iₘₐₓ is the maximum pixel value of the original image, R(x,y) is the value of red color channel of the original image, G(x,y) is the value of green color channel of the original image, B(x,y) is the value of blue color channel of the original image.

12. The method of claim 1 and further comprising using the equations:
$${C}_{Gain} \times \frac{I ( x , y )}{D ( x , y ) + {C}_{Anti \text{-} noise}} + I ( x , y )$$
$$D ( x , y ) = I ( x , y ) * F ( x , y )$$
to process a grey-scale digital image in a backlighting condition. I(x,y) is the original image, D(x,y) is the intermediate image, C_{Gain} is an gain coefficient, and C_{Anti-noise} is an anti-noise coefficient.

13. The method of claim 1 and further comprising using the equations:
$$\begin{matrix}- {C}_{Gain} \times \frac{( {I}_{max} - I ( x , y ) )}{( {I}_{max} - D ( x , y ) ) + {C}_{Anti \text{-} noise}} + I ( x , y ) \\ D ( x , y ) = I ( x , y ) * F ( x , y )\end{matrix}$$
to process a grey-scale digital image in a reflection condition.
I(x,y) is the original image, D(x,y) is the intermediate image, C_{Gain} is an gain coefficient, C_{Anti-noise} is an anti-noise coefficient, and Iₘₐₓ is the maximum pixel value of the original image.

14. A electric device for enhancing images of non-uniform brightness that is able to utilize a surround function to analyze brightness uniformity of an image; apply the obtained brightness uniformity to set a gain function to decide the required adjustments on the values of RGB (red, green and blue) color channels of each pixel; and generate an enhanced image in which the final value of a pixel is the sum of the adjusted values of R, G and B channels.

15. The electric device of claim 14 is a digital camera.

16. The electric device of claim 14 is a display or a monitor.

17. The electric device of claim 14 is a printer.

18. The device of claim 14 is an image output device.
